(19) United States
(12) Patent Application Publication
(10) Pub. No.: US 2015/0293435 A1
(43) Pub. Date: Oct. 15, 2015

(54) WRITABLE SCREEN

(71) Applicant: KIMOTO CO., LTD., Saitama-shi, Saitama (JP)

(72) Inventors: Syuuji KOHTA, Saitama-shi (JP); Hironori SATO, Saitama-shi (JP)

(73) Assignee: KIMOTO CO., LTD., Saitama-shi, Saitama (JP)

(21) Appl. No.: 14/383,025

(22) PCT Filed: Mar. 7, 2013
(86) PCT No.: PCT/JP2013/056283

§ 371 Date: Sep. 4, 2014

(30) Foreign Application Priority Data
Mar. 12, 2012 (JP) 2012-054163

(51) Int. Cl. G03B 21/60

(52) U.S. Cl. CPC G03B 21/60

(57) ABSTRACT

Provided is a writable screen that has a reduced occurrence of glare while satisfying writing/erasing properties. The writable screen results from providing a resin layer that can be written/erased by a whiteboard pen on one surface of a base material, the resin layer having a surface arithmetic mean roughness based on JIS B0601:2001 of 0.1-3.0 μm at a cutoff value of 0.8 mm and a stylus tip radius of 2.5 μm, and a surface arithmetic mean roughness based on JIS B0601:2001 of 0.05-0.20 μm at a cutoff value of 0.08 mm and a stylus tip radius of 2.5 μm.

### TECHNICAL FIELD

The present invention relates to a screen that displays an image projected from a projecting device such as a projector, and particularly to a screen with a writable and erasable surface.

### BACKGROUND ART

Conventionally, a screen which displays an image projected from a projecting device such as a projector and having a resin layer capable of writing with a whiteboard pen and erasing. It has been known that for enabling the writing with a whiteboard pen and erasing, the surface is preferably smooth.

On the other hand, making the screen have a smooth surface causes a problem of a phenomenon called hot spot in which the light source of the projecting device is seen too bright. For solving the problem, a projection screen with a particular uneven shape has been suggested (Patent Literature 1, Patent Literature 2).

### CITATION LIST

### Patent Literatures

Patent Document 1: International Publication WO01/032440 (conventional technique)
Patent Document 2: JP-A-2011-194705 (problem to be solved by the invention)

### SUMMARY OF THE INVENTION

### Problems to be Solved by the Invention

In recent years, however, as the projecting device has a brighter light source, bright spots called “glare” have come to stand out in the image projected on the screen. The bright spots called glare distribute throughout the screen, and drastically deteriorate the quality of the projected image as well as the hot spots.

In view of this, an object of the present invention is to provide a writable screen in which the glare is suppressed while the writability and erasability are satisfied.

### Solutions to the Problems

The present inventors considered that the convex on the surface of the resin layer serves as a convex lens to condense the light transmitted through the resin layer and form the bright spot. In view of this, the present inventors have conducted researches about the convex shape that does not cause “glare” and completed the present invention.

A writable screen of the present invention for solving the above problem is provided with a resin layer, on which writing with a whiteboard pen and erasing are possible, on one surface of a base material, wherein the resin layer has a surface whose arithmetic mean roughness based on JIS B0601:2001 is 0.1 to 3.0 μm when the cutoff value is 0.8 mm and the stylus tip radius is 2.5 μm, and arithmetic mean roughness based on JIS B0601:2001 is 0.05 to 0.20 μm when the cutoff value is 0.08 mm and the stylus tip radius is 2.5 μm.

### EFFECTS OF THE INVENTION

According to the present invention, the writable screen can be obtained in which the occurrence of hot spots or glare can be suppressed without deteriorating the writability and erasability with the whiteboard pen.

### BRIEF DESCRIPTION OF THE DRAWINGS

FIG. 1 is a diagram representing measurement results of Ra1 of a writable screen according to Example 1.

FIG. 2 is a diagram representing measurement results of Ra2 of the writable screen according to Example 1.

FIG. 3 is a diagram representing measurement results of Ra1 of a writable screen according to Example 6.

FIG. 4 is a diagram representing measurement results of Ra2 of the writable screen according to Example 6.

FIG. 5 is a diagram representing measurement results of Ra1 of a writable screen according to Comparative Example 2.

FIG. 6 is a diagram representing measurement results of Ra2 of the writable screen according to Comparative Example 2.

FIG. 7 is a diagram representing measurement results of Ra1 of a writable screen according to Comparative Example 3.

FIG. 8 is a diagram representing measurement results of Ra2 of the writable screen according to Comparative Example 3.

FIG. 9 is a diagram for describing a method of measuring a hot spot.

### DESCRIPTION OF EMBODIMENT

A writable screen of the present invention has a base material provided with a resin layer, on which writing with a whiteboard pen and erasing are possible, on one surface.

Examples of the base material used for the writable screen of the present invention include the homopolymer or copolymer of (meth)acrylic ester, polyesters such as polyethylene terephthalate, polybutylene terephthalate, and polyethylene naphthalate, polycarbonate, polyvinyl chloride, polystyrene, fluorine resin, other plastic films, and a metal plate. In particular, in the case of applying the present invention to a reflective screen, a white plastic film with a reflecting property is preferable. In addition, the base material may be provided with a reflection layer formed by evaporating metal such as aluminum, a reflection layer formed of aluminum paste or the like, a reflection layer formed of a white pigment, or the like.

The thickness of the base material is not particularly limited but is preferably 10 μm or more, and more preferably 20 μm or more. As for the upper limit, the thickness is preferably 300 μm or less, and more preferably 200 μm or less. A thickness of 10 μm or more can make the planarity favorable when the area is increased. In addition, a thickness of 300 μm or less can maintain the windability when the screen is formed.

The resin layer is a layer formed of a resin composition, which is described below. A surface of the resin layer has a characteristic shape. The resin layer has a surface whose arithmetic mean roughness based on JIS B0601:2001 measured with the cutoff value of 0.8 mm and the stylus tip radius of 2.5 μm (hereinafter also referred to as arithmetic mean roughness (Ra1) simply) is, and whose arithmetic mean roughness based on JIS B0601:2001 measured with the cutoff value of 0.08 mm and the stylus tip radius of 2.5 μm (hereinafter also referred to as arithmetic mean roughness (Ra2) simply) is 0.05 to 0.20 μm.

The arithmetic mean roughness (Ra1) is the value measured using a cutoff value and a stylus tip radius according to the arithmetic mean roughness (Ra) defined in JIS (Ra according to the normal measurement), and is determined based on the unevenness including the unevenness of the resin layer itself (gradient change of surface level) and the unevenness of the surface of the resin layer. The arithmetic mean roughness (Ra2) is the value obtained by measuring the roughness of the microscopic unevenness on the surface of the resin layer by reducing the cutoff value from the value in the normal measurement. In other words, the arithmetic mean roughness (Ra2) is the indicator representing what extent the unevenness of the resin layer itself and the unevenness of the surface of the resin layer defined in the arithmetic mean roughness (Ra) include more microscopic unevenness.

In a conventional writable screen, the resin layer has unevenness of such a degree that the arithmetic mean roughness (Ra1) is within a predetermined range; therefore, the surface of each convex or concave of the unevenness does not include the microscopic unevenness substantially, and the surface is flat. In such a screen, the convex of the resin layer represented by the arithmetic mean roughness (Ra1) functions as a lens to cause “glare”. In contrast to this, in the writable screen according to the present invention, in addition to the unevenness of the resin layer defined by the arithmetic mean roughness (Ra1), the microscopic unevenness within the predetermined arithmetic mean roughness (Ra2) is present on the surface of the resin layer. Therefore, the surface of the convex defined by the arithmetic mean roughness (Ra1) is further provided with the microscopic unevenness to prevent the convex from serving as a lens, thereby preventing “glare” that is caused by the lens effect.

Specifically, the arithmetic mean roughness (Ra1) is 0.1 to 3.0 μm, and preferably 0.1 μm or more, and more preferably 0.2 μm or more. As for the upper limit, the roughness is preferably 3.0 μm or less, and more preferably 2.0 μm or less. By setting the arithmetic mean roughness (Ra1) to 0.1 μm or more, the hot spot can be prevented. By setting the arithmetic mean roughness (Ra1) to 2.0 μm or less, the writability and erasability with the whiteboard pen can be provided.

The arithmetic mean roughness (Ra2) is preferably 0.05 μm or more, and more preferably 0.08 μm or more. As for the upper limit, the roughness is preferably 0.25 μm or less, and more preferably 0.20 μm or less. By setting the arithmetic mean roughness (Ra2) to 0.05 μm or more, the glare can be prevented. By setting the arithmetic mean roughness (Ra2) to 0.25 μm or less, the erasability with the whiteboard pen can be provided.

As a method of providing the resin layer with such a shape, a method of applying a resin layer containing a binder resin and a microparticle, or a method of forming a matrix with an uneven shape and then transferring this shape to the resin layer can be given.

First, description is made of a case in which the resin layer is formed as a resin layer containing a binder resin and a microparticle. Examples of the binder resin include the thermosetting hybrid resin, the thermosetting fluorine resin, the UV-curable acrylic resin, and the UV-curable urethane resin. Specifically, a product named CERANATE W series (DIC Corporation) can be used as the thermosetting hybrid resin, a product named FLUONATE (DIC Corporation) can be used as the thermosetting fluorine resin, and a product named ADEKA OPTOMER KR567 (ADEKA CORPORATION) can be used as the UV-curable resin.

The microparticle may be either inorganic or organic. The use of a spherical microparticle is preferable for improving the writability and erasability. Examples of the inorganic microparticle include silica, alumina, titanium dioxide, and calcium carbonate. Examples of the organic microparticle include acrylic resin, polystyrene, polyethylene, benzoguanamine, and nylon.

The average particle diameter and the thickness of the resin layer are preferably determined so that the microparticles are not embedded as a whole in the resin layer and the microparticles do not fall from the resin layer. Specifically, the thickness of the resin layer is preferably 1 μm or more, and more preferably 3 μm or more. As for the upper limit, the thickness is preferably 10 μm or less, and more preferably 8 μm or less. The average particle diameter of the microparticle is preferably 7 μm or less, and more preferably 5 μm or less though depending on the thickness of the resin layer. Within the above range, the microparticle can be held without being fallen off, and the desired unevenness can be formed without having the microparticle embedded in the resin layer.

The content of the microparticles in the resin layer is preferably 10 wt % or less, and more preferably 5 wt % or less. Within this range, two kinds of arithmetic mean roughness (Ra1, Ra2) can be set to be in the predetermined range, whereby the hot spot and glare can be prevented while the writability and erasability are maintained.

Next, description is made of the case of forming the resin layer by transfer. In this case, the resin may be similar to the binder resin that is used when the resin layer is formed of the binder resin and the microparticle.

First, a mold with a surface whose arithmetic mean roughness (Ra1) and arithmetic mean roughness (Ra2) are within the predetermined range is formed. Such a mold can be formed using a matrix produced by forming a layer containing the aforementioned binder resin and microparticle, or using a matrix produced by forming on a surface of, for example, a plastic, ceramic, or metal material, a desired shape designed by a production technique such as micromachining. By molding the resin such as the aforementioned thermosetting hybrid resin, thermosetting fluorine resin, UV-curable acrylic resin, UV-curable urethane resin, or the like with the use of the matrix produced as above, the shape of the mold can be transferred to the surface of the uncured resin layer that is applied on the base material. Thus, the surface of the resin layer can have the shape of the mold.

The method of transferring the shape provides the excellent erasability because the convex becomes the sharp mountain less easily and the ink of the whiteboard pen less easily enters the sharp valley part of the concave as compared with the resin layer containing the binder resin and the microparticle. In addition, the resin layer containing the microparticle may be embossed, in which case the sharp mountain part of the convex can be eliminated to improve the erasability.

Note that an additive such as a surface modifier, a leveling agent, or an antioxidant may be added to the resin layer in addition to the above resin. The addition of the additive can further improve the writability and erasability. For example, the resin layer may include a nonionic compound such as an organic silicon compound or a fluorine compound. Specific examples of the nonionic compound include dimethyl polysiloxane or a modified polysiloxane thereof with nonreactive properties, such as polyether modified dimethyl polysiloxane. The addition of such nonionic compound can improve the erasability after the writing. The nonionic compound is preferably added by 2 to 10% to the binder resin.

A writable screen of the present invention has a particular surface shape. Thus, even in the use of the projector with large light quantity of a light source, the hot spot or glare can be prevented while the writability and erasability are maintained.

### EXAMPLES

The present invention is further described with reference to examples below. Note that “part” and “%” are based on the weight unless otherwise stated.

### Example 1

A resin layer coating as described below was applied and dried on one surface of a 50-μm-thick polyester film (LUMIRROR E20: Toray Industries, Inc.), and cured by the irradiation with a UV ray, thereby forming a 5-μm-thick resin layer. Thus, a writable screen according to Example 1 was manufactured.

### <Resin Layer Coating>

| | |
|---|---|
| UV-curable resin | 25 parts by weight |
| (ADEKA OPTOMER KR567: ADEKA | 1 part by weight |
| CORPORATION, solid content 96%) spherical | |
| microparticle | |
| (GANZ PEARL GM-0401S: GANZ Chemical Co., | 55 parts by weight |
| Ltd., average particle diameter: 4 μm) diluting | |
| solvent | |

### Example 2

A writable screen according to Example 2 was manufactured in a manner similar to Example 1 except that the content of the microparticles in the resin layer of Example 1 was changed to 2 parts by weight.

### Example 3

A resin layer coating as described below was applied on one surface of a 50-μm-thick polyester film (LUMIRROR E20: Toray Industries, Inc.) and heated and dried at 120° C., and then cured, thereby forming a 5-μm-thick resin layer. Thus, a writable screen according to Example 3 was manufactured.

### <Resin Layer Coating>

| | |
|---|---|
| thermosetting resin | 32 parts by weight |
| (ACRYDIC A807: DIC Corporation, solid content | 8 parts by weight |
| 50%) Polyisocyanate | |
| (BURNOCK D800: DIC Corporation, solid content | 0.8 parts by weight |
| 50%) spherical microparticle | |
| (GANZ PEARL GM-0401S: GANZ Chemical Co., | 20 parts by weight |
| Ltd., average particle diameter: 4 μm) diluting | |
| solvent | |

### Example 4

A resin layer coating as described below was applied and dried on one surface of a 50-μm-thick polyester film (LUMIRROR E20: Toray Industries, Inc.), and cured by the irradiation with a UV ray, thereby forming a 5-μm-thick resin layer. Thus, a writable screen according to Example 4 was manufactured.

### <Resin Layer Coating>

| | |
|---|---|
| UV-curable resin | 25 parts by weight |
| (ADEKA OPTOMER KR567: ADEKA | 1 part by weight |
| CORPORATION, solid content 96%) spherical | |
| microparticle | |
| (GANZ PEARL GM-0401S: GANZ Chemical Co., | 0.6 parts by weight |
| Ltd., average particle diameter: 4 μm) additive | |
| (polyether modified dimethyl polysiloxane) | |
| (BYK333: BYK-Chemie, solid content 100%) | 55 parts by weight |
| diluting solvent | |

### Example 5

A resin layer was formed in a manner similar to Example 1, and this was used as a matrix. A UV-curable resin (ADEKA OPTOMER KR567: ADEKA CORPORATION, solid content 96%) coating was applied into the mold, and a 50-μm-thick polyester film (LUMIRROR E20: Toray Industries, Inc.) is adhered thereto. After that, the mold was removed and the resin was cured with UV irradiation to form a 5-μm-thick resin layer. Thus, a writable screen according to Example 5 was manufactured.

### Example 6

For the writable screen manufactured in Example 1, an emboss roll was thermally welded while pressure is applied thereto, whereby the unevenness with an arithmetic mean roughness (Ra1) of 2.33 μm and an arithmetic mean roughness (Ra2) of 0.14 μm was formed. Thus, a writable screen according to Example 6 was manufactured.

### Example 7

For the writable screen manufactured in Example 4, an emboss roll was thermally welded while pressure is applied thereto, whereby the unevenness with an arithmetic mean roughness (Ra1) of 2.35 μm and an arithmetic mean roughness (Ra2) of 0.15 μm was formed. Thus, a writable screen according to Example 7 was manufactured.

### Comparative Example 1

A writable screen according to Example 2 was manufactured in a manner similar to Example 1 except that the content of the microparticles in the resin layer of Example 1 was changed to 3 parts by weight.

### Comparative Example 2

A resin layer with a thickness of 5 μm was formed by applying a UV-curable resin (ADEKA OPTOMER KR567: ADEKA CORPORATION, solid content 96%) coating on one surface of a 50-μm-thick polyester film (LUMIRROR E20; Toray Industries, Inc.) and curing the coating with UV irradiation. For the surface of this resin layer, an emboss roll was thermally welded while pressure is applied thereto, whereby the unevenness with an arithmetic mean roughness (Ra1) of 2.0 μm and an arithmetic mean roughness (Ra2) of 0.01 μm was formed. Thus, a writable screen according to Comparative Example 2 was manufactured.

### Comparative Example 3

A writable screen according to Comparative Example 3 was manufactured in a manner similar to Example 1 except that the resin layer coating of Example 1 was changed to the resin layer coating as below, the thickness was set to 5 μm, and the UV ray irradiation was not conducted.

### <Resin Layer Coating>

| | |
|---|---|
| thermosetting resin | 32 parts by weight |
| (ACRYDIC A807: DIC Corporation, solid content | 8 parts by weight |
| 50%) Polyisocyanate | |
| (BURNOCK D800: DIC Corporation, solid content | 20 parts by weight |
| 50%) spherical microparticle | |
| (GANZ PEARL GM-0401S: GANZ Chemical Co., | 20 parts by weight |
| Ltd., average particle diameter: 4 μm) diluting | |
| solvent | |

### (1) Arithmetic Mean Roughness (Ra1, Ra2)

The arithmetic mean roughness (Ra1) of the resin layer of the writable screen according to each of Examples 1 to 7 and Comparative Examples 1 to 3 was measured by a surface roughness measuring device (SURFCOM 1500SD2: TOKYO SEIMITSU CO., LTD.) at a cutoff value of 0.8 mm and a stylus tip radius of 2.5 μm based on JIS B0601:2001. Similarly, the arithmetic mean roughness (Ra2) at a cutoff value of 0.08 mm and a stylus tip radius of 2.5 μm was measured. The results are shown in Table 1.

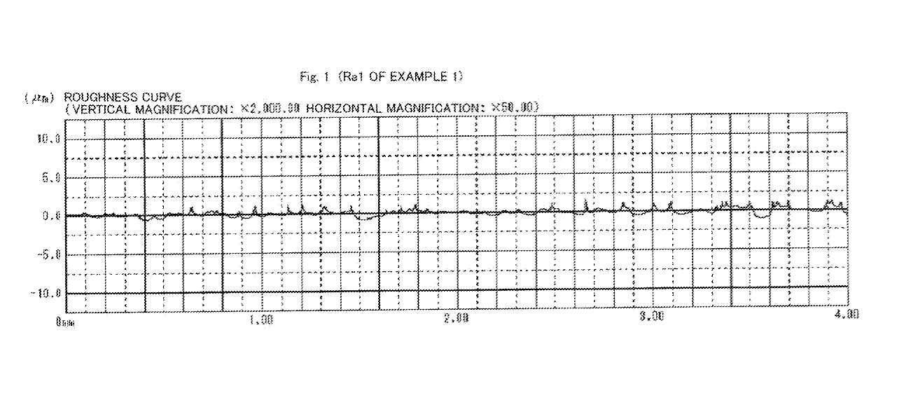

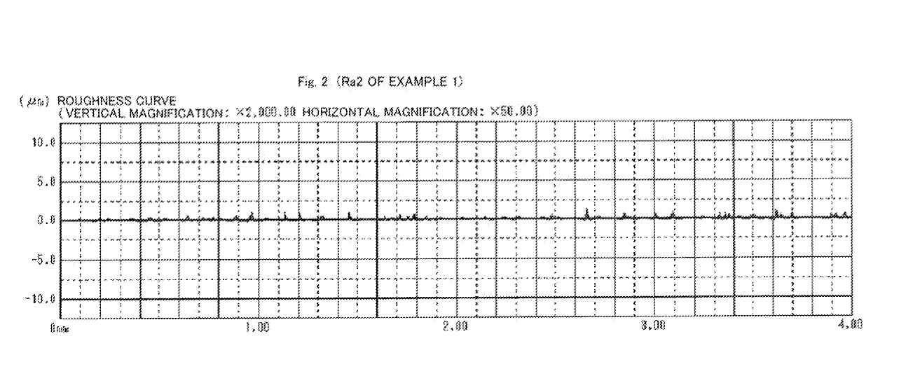

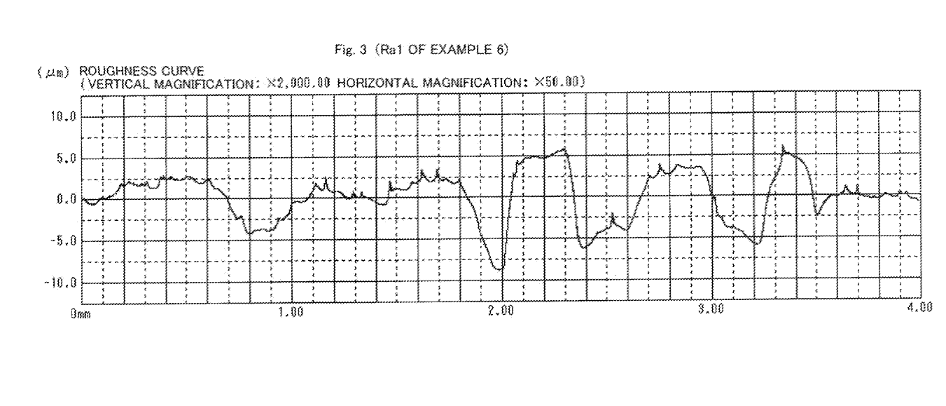

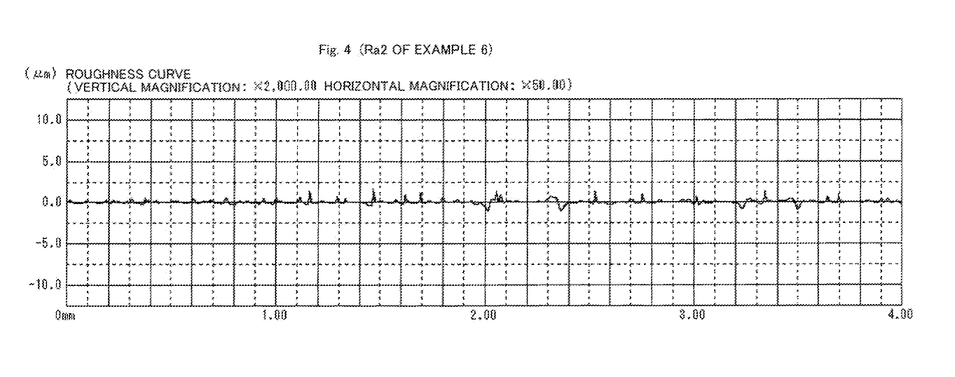

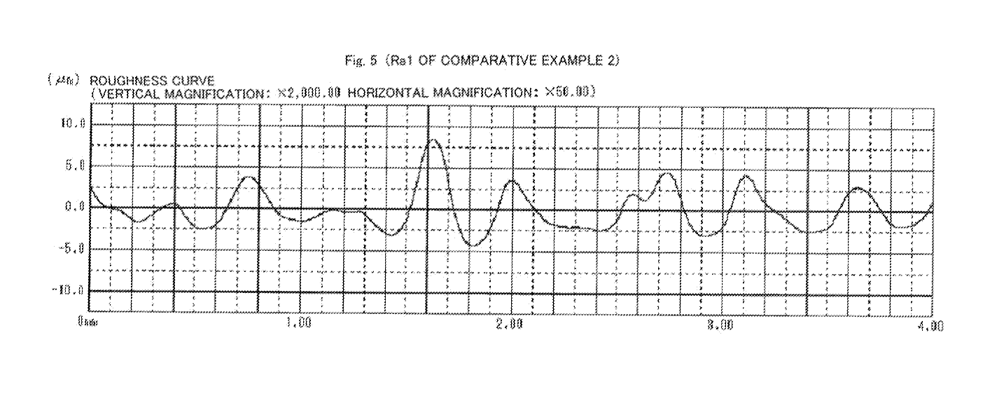

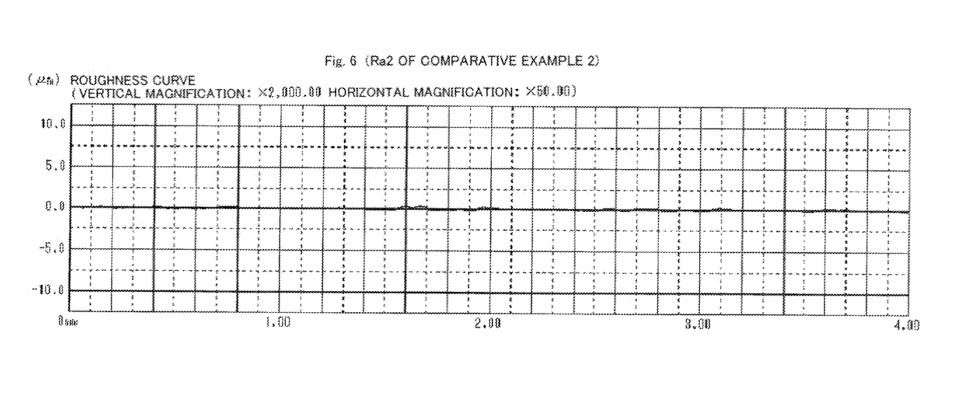

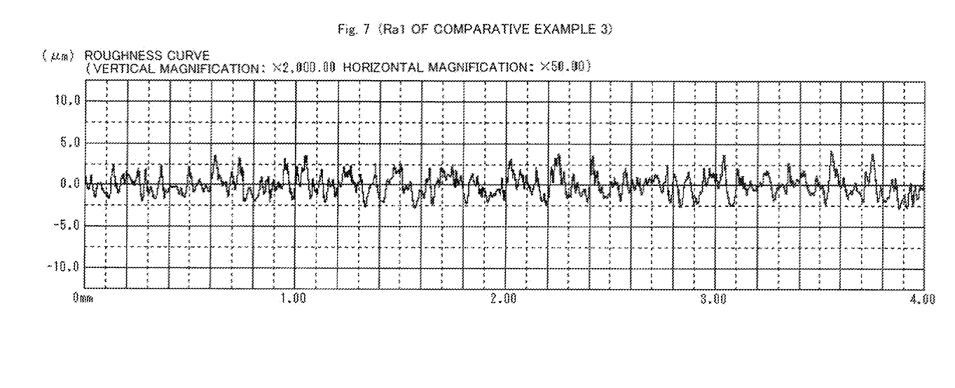

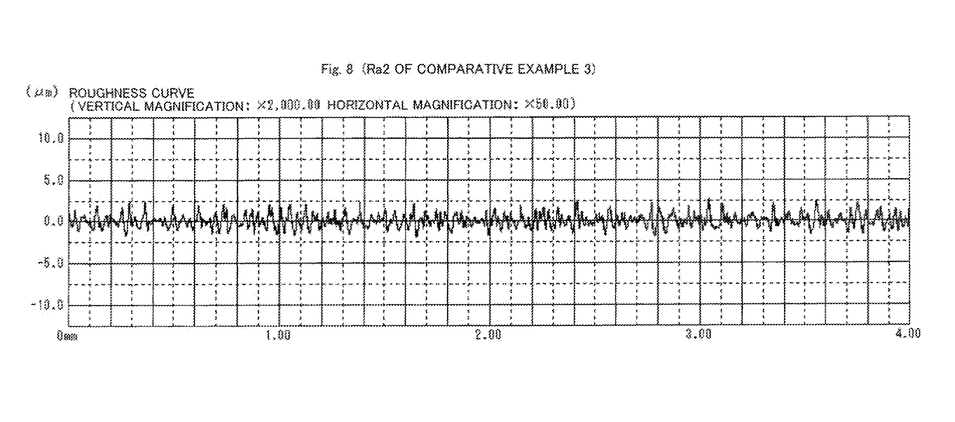

The roughness curves of Ra1 and Ra2 of the writable screen according to any of Examples 1 and 6 and Comparative Examples 2 and 3 are shown in FIG. 1 to FIG. 8.

### (2) Writability/Erasability

A letter was written on the resin layer of the writable screen according to any of Examples 1 to 7 and Comparative Examples 1 to 3 with the use of a commercial whiteboard marker and then, the letter was erased with the use of a commercial whiteboard eraser; thus, the erasability of the marker was evaluated.

As for the writability, the screen on which the letter was able to be written with the marker is represented by a symbol of a single circle and the screen on which the letter was unable to be written with the marker is represented by a symbol of an X mark.

As for the erasability, the screen on which the letter was able to be erased by being wiped once or twice without leaving the residue of the marker ink is represented by a symbol of a double circle, the screen on which the letter was able to be erased by being wiped three or four times without leaving the residue of the marker ink is represented by a symbol of a single circle, the screen which required five or more times of wiping for erasing the letter or on which the letter was unable to be erased after being wiped many times is represented by a symbol of an X mark. The results are shown in Table 1.

### (3) Hot Spot (Visual Observation)

The resin layer surface of the writable screen according to any of Examples 1 to 7 and Comparative Examples 1 to 3 was subjected to projection using a projector (MX812ST: BenQ Japan Co., Ltd.) and the presence or absence of the hot spot on the resin layer surface was observed. The screen without the hot spot is represented by a symbol of a single circle and the screen with the hot spot is represented by a symbol of an X mark. The results are shown in Table 1.

### (4) Hot Spot (Screen Gain Measurement)

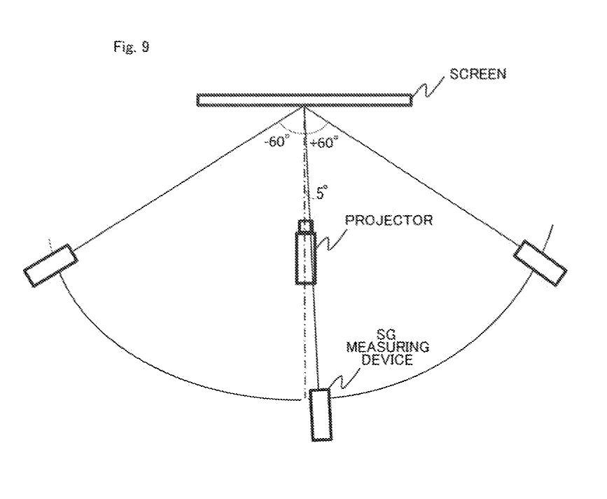

In regard to the writable screen according to any of Examples 1 to 7 and Comparative Examples 1 to 3, as shown in FIG. 9, a position of the line connecting between the projector (Data Projector U-237: PLUS Corporation) and the screen is set to Wand a luminance meter (CS-100: KONICA MINOLTA, INC) was set to a position away (approximately 1 m) from the screen more than a position of the projector. Thus, the screen gain (SG) was measured while the position of the luminance meter was varied in the range of ±60° horizontally around 0° for every 10°. Using a standard plate (total diffusion plate), an SG value was measured at a predetermined angle position to obtain a reference value, and the relative value for this reference value was calculated. The screen with a relative value of 0.3 or less is represented by a symbol of a double circle, the screen with a relative value of 0.5 or less is represented by a symbol of a single circle, and the screen with a relative value of more than 0.5 is represented by a symbol of an X mark. The results are shown in Table 1.

### (5) Glare (Bright Spot)

The writable screen according to any of Examples 1 to 7 and Comparative Examples 1 to 3 was subjected to projection with the use of a projector (MX812ST: BenQ Japan Co., Ltd.), and the presence or absence of the glare (bright spot) was observed. The screen on which glare was not observed is represented by a symbol of a single circle and the screen on which glare was observed is represented by a symbol of an X mark. Note that in the observation, the resin layer side was subjected to the projection and the resin layer side was observed (reflection) and moreover the side opposite to the resin layer was subjected to the projection and the resin layer side was observed (transmission). The results are shown in Table 1.

TABLE 1

| | Arithmetic mean | | | | Hot spot | | | |
|---|---|---|---|---|---|---|---|---|
| | roughness (μm) | | Writability/Erasability | | Visual | SG | Glare | |
| | Ra1 | Ra2 | Writability | Erasability | observation | measurement | Reflection | Transmission |
| Example 1 | 0.30 | 0.10 | ◯ | ◯ | ◯ | ◯ | ◯ | ◯ |
| Example 2 | 0.90 | 0.20 | ◯ | ◯ | ◯ | ◯ | ◯ | ◯ |
| Example 3 | 0.32 | 0.11 | ◯ | ◯ | ◯ | ◯ | ◯ | ◯ |
| Example 4 | 0.32 | 0.11 | ◯ | ⊚ | ◯ | ◯ | ◯ | ◯ |
| Example 5 | 0.38 | 0.16 | ◯ | ⊚ | ◯ | ◯ | ◯ | ◯ |
| Example 6 | 2.33 | 0.14 | ◯ | ◯ | ◯ | ⊚ | ◯ | ◯ |
| Example 7 | 2.35 | 0.15 | ◯ | ⊚ | ◯ | ⊚ | ◯ | ◯ |
| Comparative | 1.00 | 0.66 | ◯ | X | ◯ | ◯ | ◯ | ◯ |
| Example 1 | | | | | | | | |
| Comparative | 2.00 | 0.01 | ◯ | ⊚ | ◯ | ◯ | X | X |
| Example 2 | | | | | | | | |
| Comparative | 1.30 | 0.62 | ◯ | X | ◯ | ◯ | ◯ | ◯ |
| Example 3 | | | | | | | | |

The resin layer in the writable screen according to any of Examples 1 to 7 has an arithmetic mean roughness (Ra1) of 0.1 to 3.0 μm and an arithmetic mean roughness (Ra2) of 0.05 to 0.20 μm. Thus, the hot spot and the glare were prevented without deteriorating the writability and erasability.

The comparison between Examples 1 and 2, and Comparative Example 1 indicates that the increase in content of the microparticles with the same average diameter tends to increase Ra2 and deteriorate the erasability.

The writable screen according to Example 3 is different from that of Example 1 in the kind of resin; even though the kind of resin is different, the shape of the resin layer is substantially the same as that of Example 1 and the similar effect can be obtained.

In the writable screen according to any of Examples 4 and 7, the resin layer contained the organic silicon compound (nonionic compound) as the additive, and the surface had a shape with Ra1 and Ra2 that are similar to those of Examples 1 and 6 but the erasability was higher. Note that the resin layer coating of the writable screen according to Comparative Example 3 contained the nonionic compound (surface modifier) that is similar to that of Examples 4 and 7 but neither the writability nor erasability was improved.

The writable screen according to Example 5 is formed by transferring a coating type resin layer. In this screen, the valley part of the coating type resin layer serves as the convex; therefore, the convex becomes the sharp mountain less easily and the ink of the whiteboard pen less easily enters the sharp valley part of the concave. Thus, the writability and erasability are excellent.

The coating type resin layer of the writable screen according to Examples 6 and 7 has been embossed. By making the coating type resin layer more uneven, the arithmetic mean roughness (Ra1) is increased; therefore, the viewing angle of the screen to be formed is increased.

In the writable screen according to any of Comparative Examples 1 to 3, the resin layer had an arithmetic mean roughness (Ra1) of 0.1 to 3.0 μm; on the other hand, in the writable screens according to Comparative Examples 1 and 3, the resin layers had an arithmetic mean roughness (Ra2) as large as 0.66 and 0.62 μm, respectively and the erasability was low. In the writable screen according to Comparative Example 2, the resin layer has an arithmetic mean roughness (Ra2) as small as 0.01 μm and the glare was unable to be prevented.

1-8. (canceled)

9. A writable screen comprising a resin layer provided on one surface of a base material, the resin layer being capable of writing with a whiteboard pen and erasing, wherein:
the arithmetic mean roughness of a surface of the resin layer based on JIS B0601:2001 is 0.1 to 3.0 μm when a cutoff value is 0.8 mm and a stylus tip radius is 2.5 μm; and
the arithmetic mean roughness of the surface of the resin layer based on JIS B0601:2001 is 0.05 to 0.25 μm when the cutoff value is 0.08 mm and the stylus tip radius is 2.5 μm.

10. The writable screen according to claim 9, wherein the arithmetic mean roughness of the surface of the resin layer based on JIS B0601:2001 is 2.0 μm or more when the cutoff value is 0.8 mm and the stylus tip radius is 2.5 μm.

11. The writable screen according to claim 9, wherein the resin layer includes a layer containing a binder resin and a microparticle.

12. The writable screen according to claim 11, wherein the resin layer contains 10 wt % or less of microparticles with an average particle diameter of 1 μm or more and 10 μm or less.

13. The writable screen according to claim 9, wherein the resin layer is a layer not containing a microparticle.

14. The writable screen according to claim 9, wherein the resin layer contains a nonionic compound.

15. The writable screen according to claim 9, wherein the resin layer is formed by transferring a shape of a mold with a surface shape whose arithmetic mean roughness based on JIS B0601:2001 is 0.1 to 3.0 μm when the cutoff value is 0.8 mm and the stylus tip radius is 2.5 μm and arithmetic mean roughness based on JIS B0601:2001 is 0.05 to 0.25 μm when the cutoff value is 0.08 mm and the stylus tip radius is 2.5 μm.

16. The writable screen according to claim 9, wherein the resin layer is formed by embossing a resin layer with a surface whose arithmetic mean roughness based on JIS B0601:2001 is 0.1 to 3.0 μm when the cutoff value is 0.8 mm and the stylus tip radius is 2.5 μm and arithmetic mean roughness based on JIS B0601:2001 is 0.05 to 0.25 μm when the cutoff value is 0.08 mm and the stylus tip radius is 2.5 μm.

17. The writable screen according to claim 9, wherein the arithmetic mean roughness of the surface of the resin layer based on JIS B0601:2001 is 0.2 μm or less when the cutoff value is 0.08 mm and the stylus tip radius is 2.5 μm.

18. The writable screen according to claim 10, wherein the resin layer includes a layer containing a binder resin and a microparticle.

19. The writable screen according to claim 18, wherein the resin layer contains 10 wt % or less of microparticles with an average particle diameter of 1 μm or more and 10 μm or less.

20. The writable screen according to claim 10, wherein the resin layer contains a nonionic compound.

21. The writable screen according to claim 11, wherein the resin layer contains a nonionic compound.

22. The writable screen according to claim 12, wherein the resin layer contains a nonionic compound.

23. The writable screen according to claim 13, wherein the resin layer contains a nonionic compound.

24. The writable screen according to claim 18, wherein the resin layer contains a nonionic compound.
